(19) United States
(12) Patent Application Publication
(10) Pub. No.: US 2017/0039866 A1
(43) Pub. Date: Feb. 9, 2017

(54) Translator

(71) Applicant: Eric Coffee, Chicago, IL (US)

(72) Inventor: Eric Coffee, Chicago, IL (US)

(21) Appl. No.: 14/818,291

(22) Filed: Aug. 4, 2015

(51) Int. Cl. G09B 5/04; G06F 17/28

(52) U.S. Cl. CPC G09B 5/04; G06F 17/2881

(57) ABSTRACT

A portable language translator and teaching device enable translating a speech from one language to a speech in another language and helpful in learning different languages. The device includes an input unit to receive a speech in a first language; a processor operatively coupled to the input unit, the processor capable of translating the speech in the first language to a speech in a language selected from a set of second languages; an output unit operatively coupled to the processor, the output unit capable of outputting the speech in the selected language of the set of second languages; a memory module operatively coupled to the processor, wherein the memory module is capable of storing the set of language.

### CROSS REFERENCE TO RELATED APPLICATIONS

Not applicable

### FEDERALLY SPONSORED RESEARCH AND DEVELOPMENT

Not applicable.

### MICROFICHE

Not applicable

### BACKGROUND OF THE INVENTION

(1) Field of the Invention

The present invention relates generally to a language translating device. More particularly) the invention relates to a portable language translator and teaching device, capable of translating a speech in one language to a speech in another desired language for providing a variety of translation services.

(2) Background of the Invention

Traveling is an enjoyable experience shared by people around the world. Many people embrace new sites, cultures and experiences through their travels inviting all that the place has to offer. Often the most difficult challenges are faced with language barriers. Ideally, before a person travels they will learn the language of the place where they are going to ensure that they can communicate with the locals.

This is not always the case Most of the time, the traveler may learn a few phrases hoping that will get them by until they are able to find someone who speaks their native tongue. Some travelers may encounter great frustration if they find themselves unable to communicate with anyone often resorting to hand gestures and a game of charades for communication.

With the globalization of many businesses and corporations, many people in the work force are finding that communication with others who do not speak their language is becoming a more normal circumstance. Some business people may purchase translation books to assist them in communications. Many times these books do not translate the local sayings or common idiomatic expressions leaving the user embarrassed when what they meant to say is not translated in the right way.

Over the years, some devices have been developed to assist persons when traveling or simply needing something translated. For example, U.S. Pat. No. 4,381,551 by Raw Kanou et.al. discloses an electronic translator. The translator appears like a small calculator wherein the user enters a word on a keypad and then the translated word appears on the screen. This enables basic word translations, but not the full sentence structure. Alternatively, U.S. Pat. No. 4,443,856 by Shintaro Hashimoto et.al. disclose an electronic translator for modifying and speaking out sentences. The translator speaks the words entered so that the user may hear how the translated words are spoken.

Various other patents related to the above-mentioned problems are: U.S. Pat. No. 7,369,998 to Voxtec International, Inc.; U.S. Pat. No. 8,527,280 to Peter V. Boesen and US Pat. App. 20130030789 to Reginald Dalce; 20130173246 to Sheree Leung, Ethan Leung; 20140046661 to iCommunicator LLC

While these devices are handy for translation they still require the user to enter the words to be translated, which may be a tedious and time consuming task. It would be desirable in the art to provide a translator that enables a user to speak into the device rather than having to manually input the information. It would also be beneficial in the art to provide a translator that plays the sentence that was just translated for the user to hear.

### SUMMARY OF THE INVENTION

In view of the foregoing disadvantages inherent n the prior art, the general purpose of the present invention is to provide a portable language translator and teaching device configured to include all the advantages of the prior art, and to overcome the drawbacks inherent therein.

Therefore, an object of the present invention is to provide a portable language translator and teaching device that is capable of providing a translation of speech in one language to another language, thereby replacing interpreters and language translation books.

Another object of the present invention to provide a portable language translator and teaching device that may be handy and comfortable to use.

Another object of the present invention to provide a portable language translator and teaching device that may enable the learning of different languages.

Still another object of the present invention is to provide a portable language translator and teaching device that may enable a smooth communication between users.

In light of the above objects, in one aspect, the present invention provides portable language translator and teaching device. The language translator and teaching device is capable of translating a speech in a first language to a language selected from a set of second languages. The translating system includes an input unit, a processor operatively coupled to the input unit, and an output unit preferably operatively coupled to the processor. In operation, the input Unit receives the speech in the first language. Thereafter, the processor translates the speech in the first language to the speech in the language selected from the set of second languages. Subsequently, the speech in the selected language may be output from the output unit.

In another aspect, the present invention provides a portable language translator and teaching device for use in a portable electronic device, thereby making the speech translating system handy and comfortable to use.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

These together with other objects of the invention, along with the various features of novelty which characterize the invention, are pointed out with particularity in the disclosure. For a better understanding of the invention, its operating advantages and the specific objects attained by its uses, reference should be had to the accompanying drawings and descriptive matter in which there are illustrated preferred embodiments of the invention.

### DESCRIPTION OF THE DRAWINGS

The invention will be better understood and objects other than those set forth above will become apparent when consideration is given to the following detailed description thereof. Such description makes reference to the annexed drawings wherein:

FIG. 1 is a perspective view of the portable language translator and teaching device according to an embodiment of the present invention;

FIG. 2 illustrates a side view of the portable language translator and teaching device illustrated in FIG. 1; and

FIG. 3 illustrates a detachable headband incorporating in the speech translating system illustrated in FIG. 1.

FIG. 4 illustrates side view of preferred embodiment of the portable language translator and teaching device.

FIG. 5 illustrates perspective view of the preferred embodiment of present invention.

FIG. 6 illustrates different views of the detachable car piece of the portable language translator and teaching device.

### DETAILED DESCRIPTION OF THE INVENTION

In the following detailed description, reference is made to the accompanying drawings which form a part hereof, and in which is shown by way of illustration specific embodiments in which the invention may be practiced. These embodiments are described in sufficient detail to enable those skilled in the art to practice the invention, and it is to be understood that the embodiments may be combined, or that other embodiments may be utilized and that structural, logical and electrical changes may be made without departing from the spirit and scope of the present invention. The following detailed description is, therefore, not to be taken in a limiting sense, and the scope of the present invention is defined by the appended claims and their equivalents.

The present invention discloses a portable language translator and teaching device. The language translator and teaching device enable translating a speech from one language to a speech in another language. More specifically, the language translator and teaching device capable of interpreting the meaning of a word or words in one language and thereafter providing an equivalent word or phrase in another language. The language translating system enables bridging a communication gap between people.

In a preferred embodiment a portable language translator and teaching device is depicted. The translator is configured to be a limited user device in order to facilitate portability and ease of use as a translator. Further, the translator is limited to certain translator specific functions in order to limit the costs associated with the development and manufacturing of translators, thereby providing a user with a device that is affordable while providing the desired translator functionality.

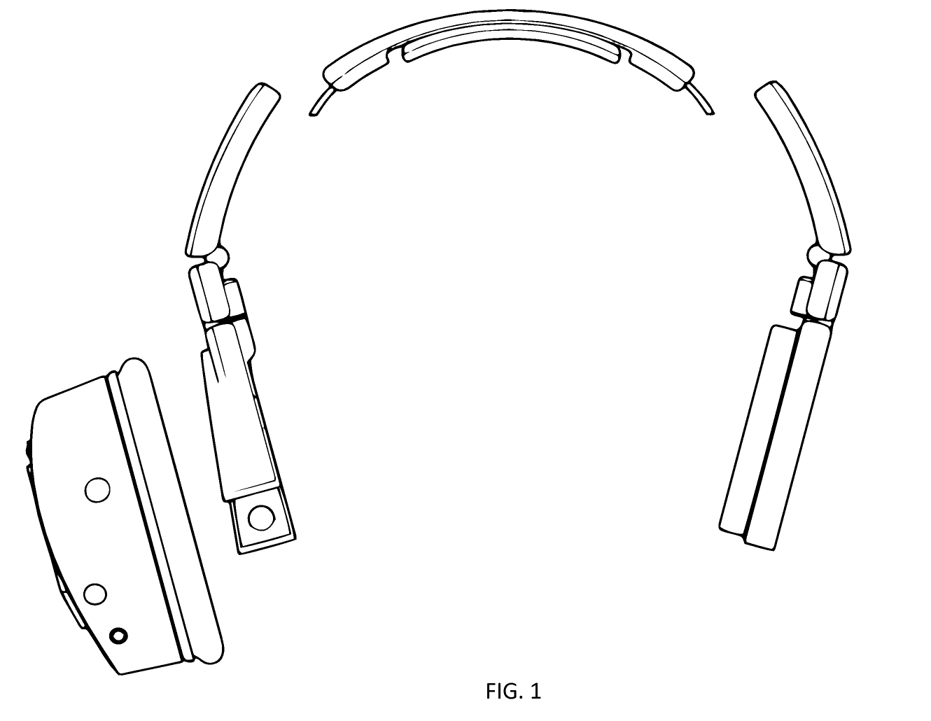

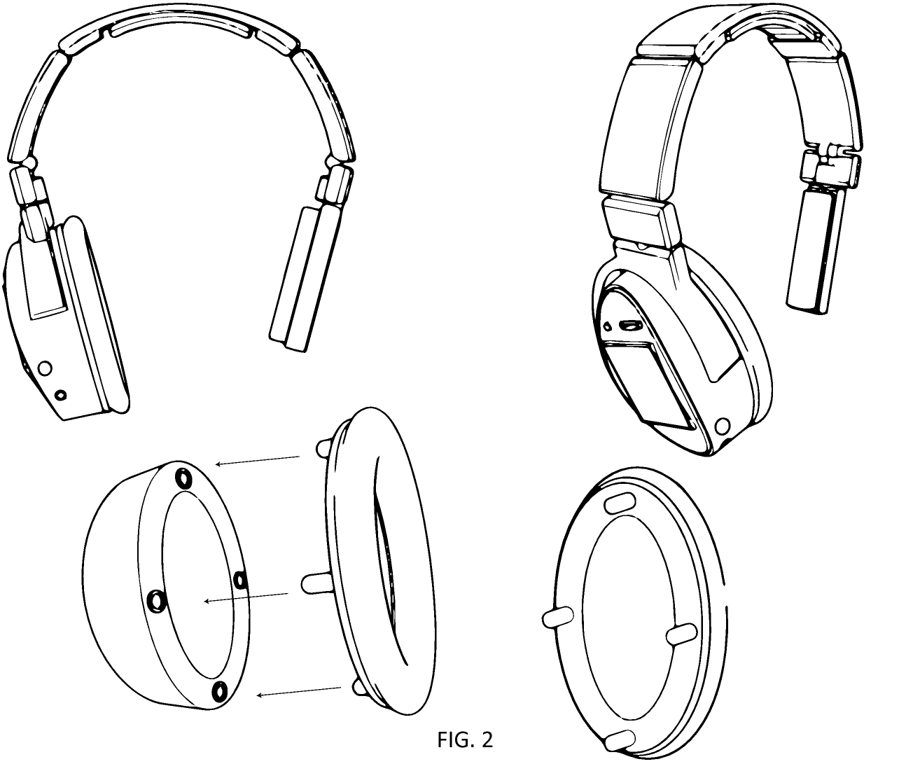

Referring to FIG. 1 and FIG. 2, a diagram of a portable language translator and teaching device, hereinafter referred to as a device, is illustrated. The device may be used for translating a speech in a first language to a language selected from a set of second languages. The system includes an input unit, a processor, and an output unit. The input unit is capable of receiving the speech in the first language. In one embodiment of the present invention, the input unit is a microphone 13. The input unit may be operatively coupled to the processor. The processor is capable of translating the speech received in the first language to a speech in the second language. The speech in the selected language, hereinafter referred to as the translated speech, may be delivered to a user by means of the output unit. The output unit may be at least one of a headphone, a built-in speaker, and an external speaker. More specifically, when it is desired to make the translated speech audible to other users, a speaker may be utilized as the output unit. However, when the user wants to avoid any other person from listening to the translated speech, the user may utilize a headphone as the output unit for listening to the translated speech in the selected language.

In another embodiment a translation assembly comprises a Bluetooth, a memory card, a switch or multi-key to activate or deactivate a volume button and Microchip having storage of around 6005 languages. It can also have additional components such as digital memory devices, and at least one microprocessor for controlling and performing the various features and functions of the translator. The translator is an electronic device powered by one or more electronic power source. Preferably, the translator is powered by one or more DC batteries 17. In one embodiment, the translator may include a wide variety of input, output, and data transfer devices and ports. For example, the translator may include one or more USB ports 15 to facilitate the connection or disconnection of the language translator with external devices such as cell phones, tablets, T.V., computer, home stereos, car, radios, etc. It is a preference of the invention that the translator to be used is fast and powerful, yet small and lightweight.

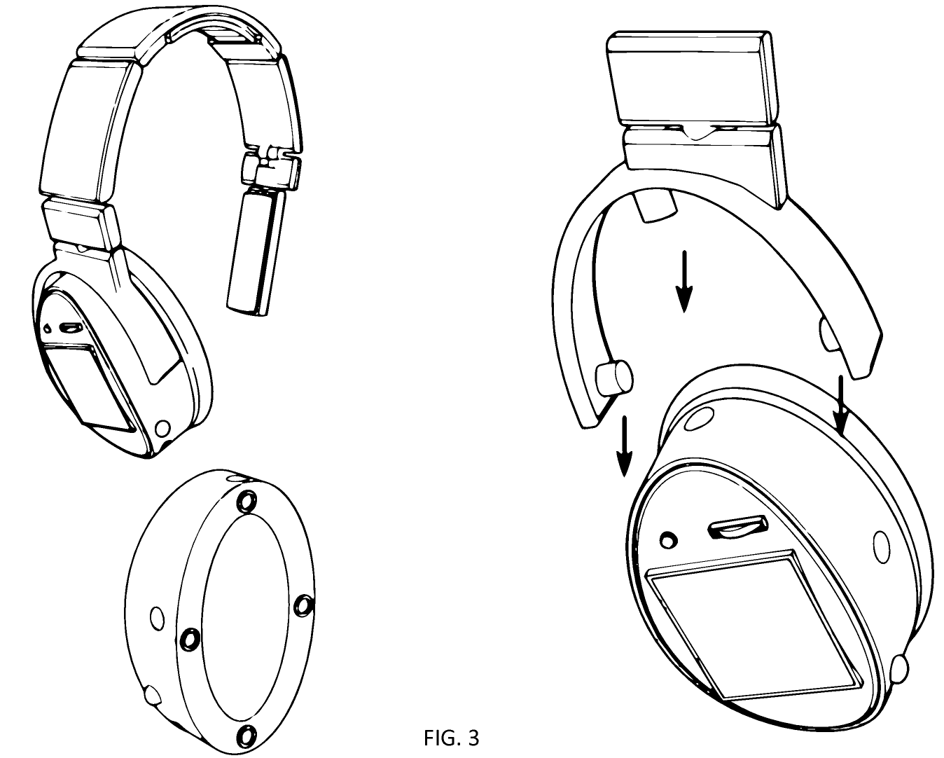

In addition, the device may also comprise a leather padded headband as shown in FIG. 3 on the top of the device. Leather foam Headband 22 is adjustable in nature which is attached any of three different point of the device and make it easy to carry.

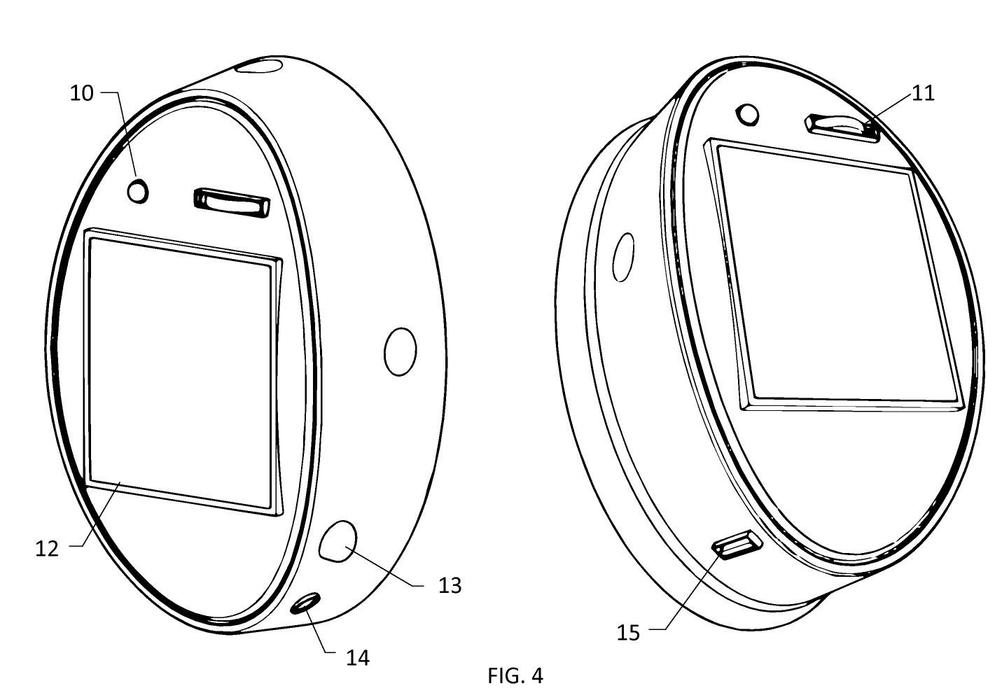

The preferred embodiment of translator has a display which is configured as a touch screen 12. The display is positioned on a face of the translator. As shown in FIG. 4. Inputs onto touch screen 12, the display may be made with a user's finger, or the inputs may be made by other means, such as a stylus pen or pencil. Translator screen further includes a list of setting for selecting different modes of operations. For example, a user can selectively choose categories of items the user would like translated.

The translator has a wide variety of modes of operation, including: a “translate” mode, in which a user inputs a language and translator, translate the corresponding language; a “learn” mode, in which a user interactively practices her language skills. In addition, it will be appreciated that the translator may include a wide variety of other features and components that may or may not be directly related to language translation, such as an alarm clock with timer. FIG. 4 further illustrates a volume control 11, power on/off switch 10 and audio input/output slot which also form a part of translator.

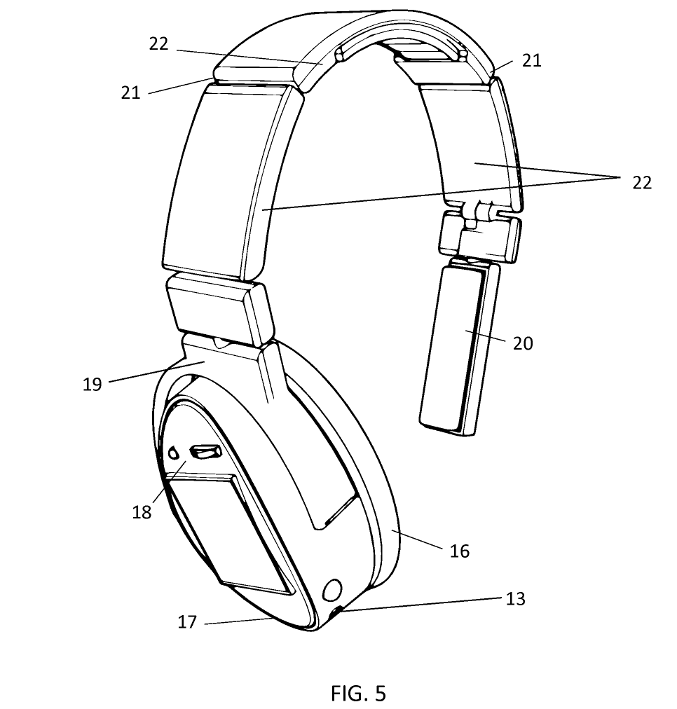

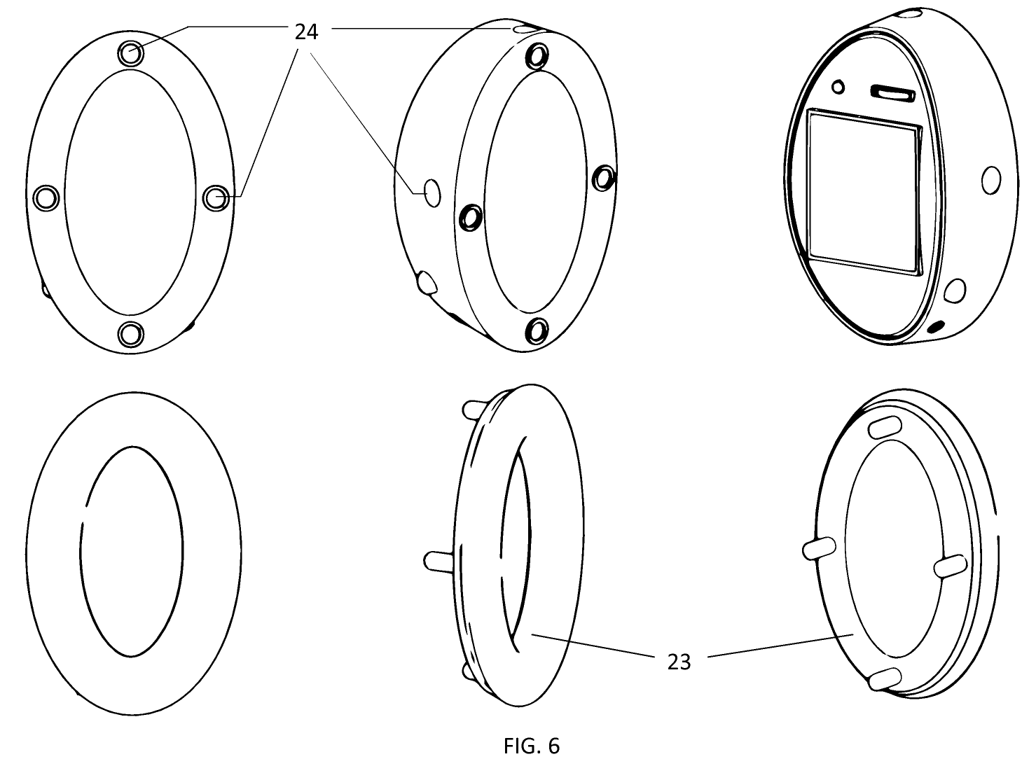

Similarly, FIG. 5 illustrates an detachable leather sponge 16 which forms the outermost part of the headphone. The sponge 16 is soft and sits easily on ear of user. A housing for speaker 18, detachable arm 19, leather sponge 20 and adjustable arm 21 are also shown in the figure, Further, FIG. 6 shows a detachable ear piece 22 and connectors 23.

It is to be understood that the above description is intended to be illustrative, and not restrictive. For example, the above-discussed embodiments may be used in combination with each other. Many other embodiments will be apparent to those of skill in the art upon reviewing the above description.

The benefits and advantages which may be provided by the present invention have been described above with regard to specific embodiments. These benefits and advantages, and any elements or limitations that may cause them to occur or to become more pronounced are not to be construed as critical, required, or essential features of any or all of the embodiments.

While the present invention has been described with reference to particular embodiments, it should be understood that the embodiments are illustrative and that the scope of the invention is not limited to these embodiments. Many variations, modifications, additions and improvements to the embodiments described above are possible. It is contemplated that these variations, modifications, additions and improvements fall within the scope of the invention.

I Claim:

1. A portable language translator and teaching device comprising:
an input unit to receive a speech in a first language;
a processor operatively coupled to the input unit, the processor capable of translating the speech in the first language to a speech in a language selected from a set of second languages;
an output unit operatively coupled to the processor, the output unit capable of outputting the speech in the selected language of the set of second languages; and
a memory module operatively coupled to the processor.

2. The portable language translator and teaching device of claim 1, wherein said input unit is a microphone. 3, The portable language translator and teaching device of claim 1, wherein said output unit is a set of headphones, a built in speaker and an external speaker.

4. The portable language translator and teaching device of claim 1, wherein said wherein said memory module is capable of storing the set of language.

5. A portable language translator and teaching device enable translating a speech from one language to a speech in another language comprising:
a memory card for storing a standard database;
a microchip having storage of around 6005 languages contained thereof;
a Bluetooth;
a leather padded headband;
one or more USB ports to facilitate the connection or disconnection of the said language translator with external devices;
a battery for powering the translator; and
a touch screen display located on a face of the case.

6. The portable language translator and teaching device of claim 5, wherein said headband is adjustable in nature which is attached any of three different point of said device and make it easy to carry.

7. The portable language translator and teaching device of claim 5, wherein said screen further includes a list of setting for selecting different modes of operations.

7. A portable language translator and teaching device enable translating a speech from one language to a speech in another language comprising:
a memory card for storing a standard database;
a microchip having storage of around 6005 languages contained thereof;
a Bluetooth;
a leather padded headband;
one or more USB ports to facilitate the connection or disconnection of the said language translator with external devices;
a battery for powering the translator;
a touch screen display located on a face of the case;
wherein, the digital sign language translator is small and portable so as to be conveniently transported by the user in order to be handily available to the user as desired; and
wherein, the translator includes a wide variety of other features and components that may or may not be directly related to language translation, such as an alarm clock with timer.
